(19) United States
(12) Patent Application Publication
(10) Pub. No.: US 2015/0288965 A1
(43) Pub. Date: Oct. 8, 2015

(54) ADAPTIVE QUANTIZATION FOR VIDEO RATE CONTROL

(71) Applicant: Microsoft Corporation, Redmond, WA (US)

(72) Inventors: Yuechuan Li, Issaquah, WA (US); Yongjun Wu, Bellevue, WA (US); Sudhakar V. Prabhu, Bellevue, WA (US); Haoyun Wu, Redmond, WA (US)

(73) Assignee: Microsoft Corporation

(21) Appl. No.: 14/495,210

(22) Filed: Sep. 24, 2014

Related U.S. Application Data
(60) Provisional application No. 61/976,979, filed on Apr. 8, 2014.

(51) Int. Cl. H04N 19/124

(52) U.S. Cl. CPC H04N 19/124

(57) ABSTRACT

According to a first aspect of the innovations described herein video encoding, such as game video encoding, is improved with a goal to generate substantially constant video quality and the average target bitrate within a desired tolerance, which improves an overall user experience on video playback. An adaptive solution uses intelligent bias on bit allocation and quantization decisions, locally within a frame and globally across different frames, based on a current quality level and within an allowed bitrate variable tolerance. Bit allocation is increased on high complexity frames and redundant bits are avoided, which might have been wasted for static scenes and low complexity aspects. Statistics can be used from the encoding process. The solution can address similar video coding quality problems for video game recording on a variety of gaming platforms.

### CROSS REFERENCE TO RELATED APPLICATION

This application claims priority from U.S. Provisional Application No. 61/976,979, filed Apr. 8, 2014, which application is incorporated herein by reference in its entirety.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last two decades, various video codec standards have been adopted, including the ITU-T H.261, H.262 (MPEG-2 or ISO/IEC 13818-2), H.263 and H.264 (MPEG-4 AVC or ISO/IEC 14496-10) standards, the MPEG-1 (ISO/IEC 11172-2) and MPEG-4 Visual (ISO/IEC 14496-2) standards, (WebM) VP8, VP9, and the SMPTE 421M (VC-1) standard. More recently, the H.265/HEVC standard (ITU-T H.265 or ISO/IEC 23008-2) has been approved. Extensions to the H.265/HEVC standard (e.g., for scalable video coding/decoding, for coding/decoding of video with higher fidelity in terms of sample bit depth or chroma sampling rate, for screen capture content, or for multi-view coding/decoding) are currently under development. A video codec standard typically defines options for the syntax of an encoded video bitstream, detailing parameters in the bitstream when particular features are used in encoding and decoding. In many cases, a video codec standard also provides details about the decoding operations a decoder should perform to achieve conforming results in decoding. Aside from codec standards, various proprietary codec formats define other options for the syntax of an encoded video bitstream and corresponding decoding operations.

Given the importance of video compression to digital video, it is not surprising that video compression is a richly developed field. Whatever the benefits of previous video compression techniques, however, there are still problems.

In particular, real-time game video encoding is challenging because game content includes a high level of detail and high complexity. Additionally, game player's behavior is unpredictable. For example, complexity variation from game video content is high due to rapid scene changes between static and dynamic motion.

Existing implementations include a traditional TM5 (MPEG-2) like variable rate control solution. But with such solutions, due to the high variation in game content, video quality can swing dramatically, leading to a bad overall user experience.

### SUMMARY

In summary, the detailed description presents innovations in encoder-side decisions for coding of screen and game content video or other video. For example, according to a first aspect of the innovations described herein, video encoding, such as game video encoding, is designed to generate substantially constant video quality with the average target bitrate within a desired tolerance, so as to improve an overall user experience.

In one embodiment, an adaptive solution uses intelligent bias on bit allocation and quantization decisions, locally within a frame and globally across different frames, based on a current quality level and within an allowed bitrate variable tolerance. Bit allocation is increased on high complexity frames and redundant bits are avoided, which might have been wasted for static scenes and low complexity aspects. Statistics can be used from the encoding process to further enhance the user experience. The solution can address video coding quality problems for video game recording on a variety of gaming platforms.

The innovations for encoder-side decisions can be implemented as part of a method, as part of a computing device adapted to perform the method or as part of a tangible computer-readable media storing computer-executable instructions for causing a computing device to perform the method. The various innovations can be used in combination or separately.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of an example computing system in which some described embodiments can be implemented.

FIGS. 2a and 2b are diagrams of example network environments in which some described embodiments can be implemented.

FIG. 3 is a diagram of an example encoder system in conjunction with which some described embodiments can be implemented.

FIGS. 4a and 4b are diagrams illustrating an example video encoder in conjunction with which some described embodiments can be implemented.

FIG. 5 is an overall system view of an encoding control according to one embodiment, the encoding control including a long-term adjustment, a short-term overshoot control, and a buffer regulator.

FIG. 6 is an embodiment of a long-term adjustment of FIG. 5.

FIG. 7 is an embodiment of a short-term overshoot control of FIG. 5.

FIG. 8 is an embodiment of a buffer regulator of FIG. 5.

FIG. 9 is a flowchart of a method for adaptively maintaining a quality level of a video stream.

FIG. 10 is a flowchart of a method according to another embodiment for adaptively maintaining a quality level of a video stream.

### DETAILED DESCRIPTION

The present application relates to techniques and tools for efficient compression of video. In various described embodiments, a video encoder incorporates techniques for encoding video at a substantially constant quality level for a video stream. Some of the described techniques and tools are particularly applicable to gaming applications.

Various alternatives to the implementations described herein are possible. For example, techniques described with reference to flowchart diagrams can be altered by changing the ordering of stages shown in the flowcharts, by repeating or omitting certain stages, etc. For example, initial stages an analysis can be completed before later stages begin, or operations for the different stages can be interleaved on a block-by-block, macroblock-by-macroblock, or other region-by-region basis.

The various techniques and tools can be used in combination or independently. Different embodiments implement one or more of the described techniques and tools. Some techniques and tools described herein can be used in a video encoder, or in some other system not specifically limited to video encoding. For example, although operations described herein are in places described as being performed by a video encoder, in many cases the operations can be performed by another type of media processing tool (e.g., image encoder and other data encoder).

Some of the innovations described herein are illustrated with reference to syntax elements and operations specific to the H.264 standard or HEVC standard. Alternatively, the innovations can be used in conjunction with encoding for another standard or format.

More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

### I. Example Computing Systems

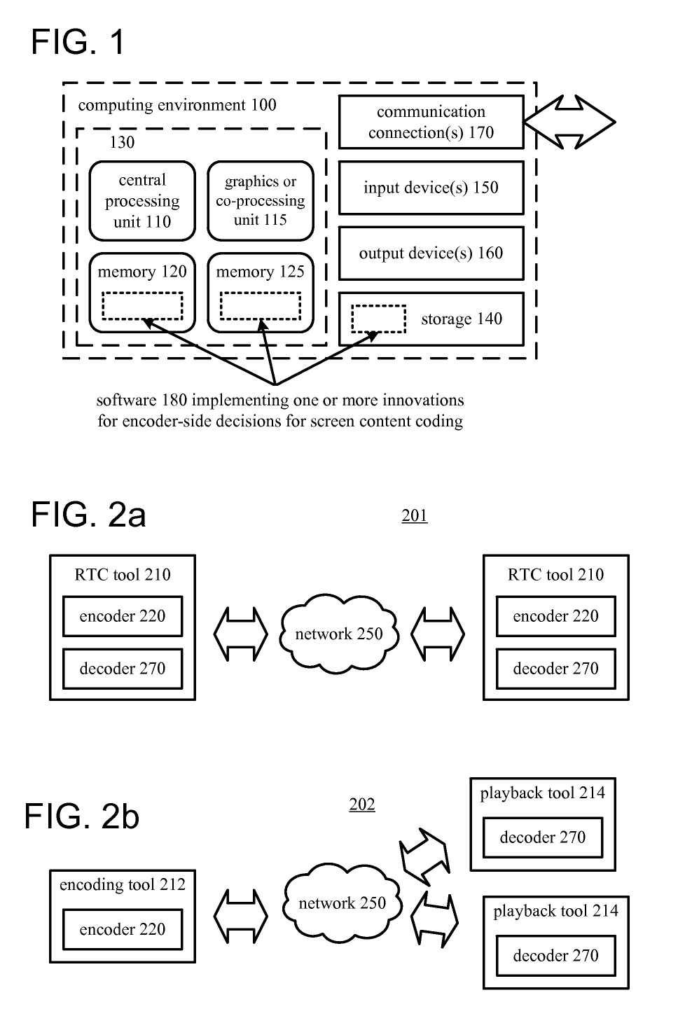

FIG. 1 illustrates a generalized example of a suitable computing system (100) in which several of the described innovations may be implemented. The computing system (100) is not intended to suggest any limitation as to scope of use or functionality, as the innovations may be implemented in diverse general-purpose or special-purpose computing systems.

With reference to FIG. 1, the computing system (100) includes one or more processing units (110, 115) and memory (120, 125). The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a central processing unit (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for video rate control, in the form of computer-executable instructions suitable for execution by the processing unit(s).

A computing system may have additional features. For example, the computing system (100) includes storage (140), one or more input devices (150), one or more output devices (160), and one or more communication connections (170). An interconnection mechanism (not shown) such as a bus, controller, or network interconnects the components of the computing system (100). Typically, operating system software (not shown) provides an operating environment for other software executing in the computing system (100), and coordinates activities of the components of the computing system (100).

The tangible storage (140) may be removable or non-removable, and includes magnetic disks, magnetic tapes or cassettes, CD-ROMs, DVDs, or any other medium which can be used to store information and which can be accessed within the computing system (100). The storage (140) stores instructions for the software (180) implementing one or more innovations for video rate control.

The input device(s) (150) may be a touch input device such as a keyboard, mouse, pen, or trackball, a voice input device, a scanning device, or another device that provides input to the computing system (100). For video, the input device(s) (150) may be a camera, video card, TV tuner card, screen capture module (e.g., for gameplay video), or similar device that accepts video input in analog or digital form, or a CD-ROM or CD-RW that reads video input into the computing system (100). The output device(s) (160) may be a display, printer, speaker, CD-writer, or another device that provides output from the computing system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system (100), computer-readable media include memory (120, 125), storage (140), and combinations of any of the above.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC such as an ASIC digital signal processor (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### II. Example Network Environments

FIGS. 2a and 2b show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2a, each real-time communication (“RTC”) tool (210) includes both an encoder (220) and a decoder (270) for bidirectional communication. A given encoder (220) can produce output compliant with a variation or extension of the H.265/HEVC standard, SMPTE 421M standard, ISO-IEC 14496-10 standard (also known as H.264 or AVC), WebM, another standard, or a proprietary format, with a corresponding decoder (270) accepting encoded data from the encoder (220). The bidirectional communication can be part of a video conference, video telephone call, or other two-party or multi-party communication scenario. Although the network environment (201) in FIG. 2a includes two real-time communication tools (210), the network environment (201) can instead include three or more real-time communication tools (210) that participate in multi-party communication.

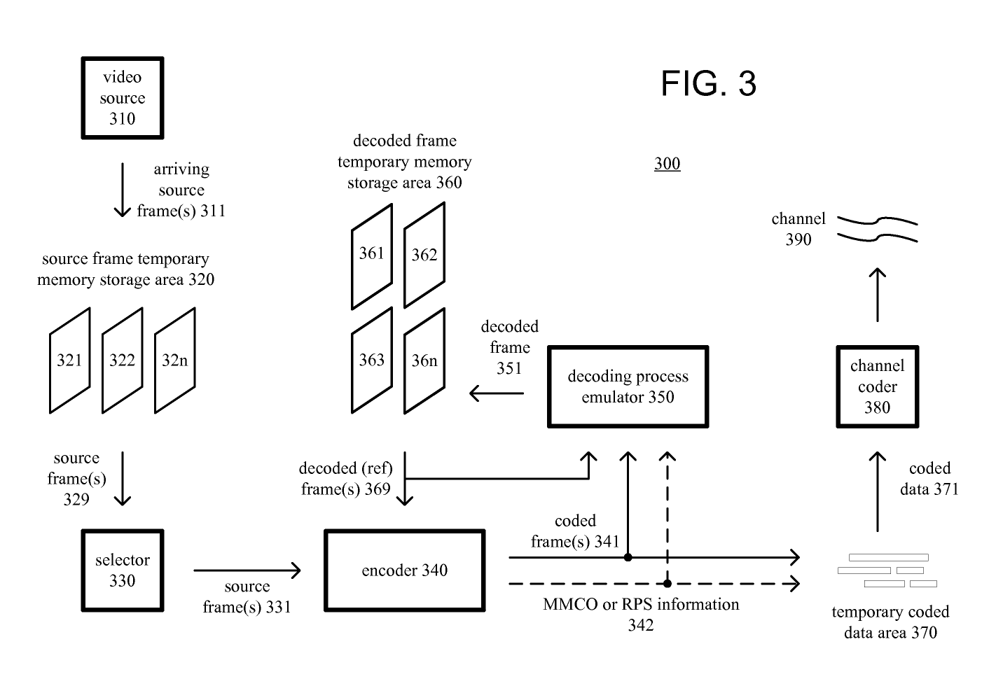

A real-time communication tool (210) manages encoding by an encoder (220). FIG. 3 shows an example encoder system (300) that can be included in the real-time communication tool (210). Alternatively, the real-time communication tool (210) uses another encoder system. A real-time communication tool (210) also manages decoding by a decoder (270).

In the network environment (202) shown in FIG. 2b, an encoding tool (212) includes an encoder (220) that encodes video for delivery to multiple playback tools (214), which include decoders (270). The unidirectional communication can be provided for a video surveillance system, web camera monitoring system, screen capture module, remote desktop conferencing presentation, game video broadcast or other scenario in which video is encoded and sent from one location to one or more other locations. Although the network environment (202) in FIG. 2b includes two playback tools (214), the network environment (202) can include more or fewer playback tools (214). In general, a playback tool (214) communicates with the encoding tool (212) to determine a stream of video for the playback tool (214) to receive. The playback tool (214) receives the stream, buffers the received encoded data for an appropriate period, and begins decoding and playback.

FIG. 3 shows an example encoder system (300) that can be included in the encoding tool (212). Alternatively, the encoding tool (212) uses another encoder system. The encoding tool (212) can also include server-side controller logic for managing connections with one or more playback tools (214). A playback tool (214) can also include client-side controller logic for managing connections with the encoding tool (212).

### III. Example Encoder Systems

FIG. 3 is a block diagram of an example encoder system (300) in conjunction with which some described embodiments may be implemented. The encoder system (300) can be a general-purpose encoding tool capable of operating in any of multiple encoding modes such as a low-latency encoding mode for real-time communication or game video broadcasting, a transcoding mode, and a higher-latency encoding mode for producing media for playback from a file or stream, or it can be a special-purpose encoding tool adapted for one such encoding mode. The encoder system (300) can be adapted for encoding of a particular type of content (e.g., screen capture content, game video). The encoder system (300) can be implemented as an operating system module, as part of an application library or as a standalone application. Overall, the encoder system (300) receives a sequence of source video frames (311) from a video source (310) and produces encoded data as output to a channel (390). The encoded data output to the channel can include content encoded using encoder-side decisions as described herein.

The video source (310) can be a camera, tuner card, storage media, screen capture module, or other digital video source, such as a gaming application. The video source (310) produces a sequence of video frames at a frame rate of, for example, 30 frames per second. As used herein, the term “frame” generally refers to source, coded or reconstructed image data. For progressive-scan video, a frame is a progressive-scan video frame. For interlaced video, in example embodiments, an interlaced video frame might be de-interlaced prior to encoding. Alternatively, two complementary interlaced video fields are encoded together as a single video frame or encoded as two separately-encoded fields. Aside from indicating a progressive-scan video frame or interlaced-scan video frame, the term “frame” or “picture” can indicate a single non-paired video field, a complementary pair of video fields, a video object plane that represents a video object at a given time, or a region of interest in a larger image. The video object plane or region can be part of a larger image that includes multiple objects or regions of a scene.

An arriving source frame (311) is stored in a source frame temporary memory storage area (320) that includes multiple frame buffer storage areas (321, 322, . . . , 32n). A frame buffer (321, 322, etc.) holds one source frame in the source frame storage area (320). After one or more of the source frames (311) have been stored in frame buffers (321, 322, etc.), a frame selector (330) selects an individual source frame from the source frame storage area (320). The order in which frames are selected by the frame selector (330) for input to the encoder (340) may differ from the order in which the frames are produced by the video source (310), e.g., the encoding of some frames may be delayed in order, so as to allow some later frames to be encoded first and to thus facilitate temporally backward prediction. Before the encoder (340), the encoder system (300) can include a pre-processor (not shown) that performs pre-processing (e.g., filtering) of the selected frame (331) before encoding. The pre-processing can include color space conversion into primary (e.g., luma) and secondary (e.g., chroma differences toward red and toward blue) components and resampling processing (e.g., to reduce the spatial resolution of chroma components) for encoding. Typically, before encoding, video has been converted to a color space such as YUV, in which sample values of a luma (Y) component represent brightness or intensity values, and sample values of chroma (U, V) components represent color-difference values. The precise definitions of the color-difference values (and conversion operations to/from YUV color space to another color space such as RGB) depend on implementation. In general, as used herein, the term YUV indicates any color space with a luma (or luminance) component and one or more chroma (or chrominance) components, including Y′UV, YIQ, Y′IQ and YDbDr as well as variations such as YCbCr and YCoCg. The chroma sample values may be sub-sampled to a lower chroma sampling rate (e.g., for YUV 4:2:0 format), or the chroma sample values may have the same resolution as the luma sample values (e.g., for YUV 4:4:4 format). Or, the video can be encoded in another format (e.g., RGB 4:4:4 format, GBR 4:4:4 format or BGR 4:4:4 format).

The encoder (340) encodes the selected frame (331) to produce a coded frame (341) and also produces memory management control operation (“MMCO”) signals (342) or reference picture set (“RPS”) information. The RPS is the set of frames that may be used for reference in motion compensation for a current frame or any subsequent frame. If the current frame is not the first frame that has been encoded, when performing its encoding process, the encoder (340) may use one or more previously encoded/decoded frames (369) that have been stored in a decoded frame temporary memory storage area (360). Such stored decoded frames (369) are used as reference frames for inter-frame prediction of the content of the current source frame (331). The MMCO/RPS information (342) indicates to a decoder which reconstructed frames may be used as reference frames, and hence should be stored in a frame storage area.

Generally, the encoder (340) includes multiple encoding modules that perform encoding tasks such as partitioning into slices and tiles, intra prediction estimation and prediction, motion estimation and compensation, frequency transforms, quantization and entropy coding. The exact operations performed by the encoder (340) can vary depending on compression format. The format of the output encoded data can be a variation or extension of H.265/HEVC format, Windows Media Video format, VC-1 format, MPEG-x format (e.g., MPEG-1, MPEG-2, or MPEG-4), H.26x format (e.g., H.261, H.262, H.263, H.264), or another format.

The encoder (340) can partition a frame into multiple slices of the same size or different sizes, where a slice can be an entire frame or region of the frame. A slice can be decoded independently of other slices in a frame, which improves error resilience. The content of a slice is further partitioned into blocks or other sets of sample values for purposes of encoding and decoding.

For syntax according to the H.265/HEVC standard, the encoder splits the content of a frame (or slice or tile) into coding tree units. A coding tree unit (“CTU”) includes luma sample values organized as a luma coding tree block (“CTB”) and corresponding chroma sample values organized as two chroma CTBs. The size of a CTU (and its CTBs) is selected by the encoder, and can be, for example, 64×64, 32×32 or 16×16 sample values. A CTU includes one or more coding units. A coding unit (“CU”) has a luma coding block (“CB”) and two corresponding chroma CBs. For example, a CTU with a 64×64 luma CTB and two 64×64 chroma CTBs (YUV 4:4:4 format) can be split into four CUs, with each CU including a 32×32 luma CB and two 32×32 chroma CBs, and with each CU possibly being split further into smaller CUs. Or, as another example, a CTU with a 64×64 luma CTB and two 32×32 chroma CTBs (YUV 4:2:0 format) can be split into four CUs, with each CU including a 32×32 luma CB and two 16×16 chroma CBs, and with each CU possibly being split further into smaller CUs. The smallest allowable size of CU (e.g., 8×8, 16×16) can be signaled in the bitstream.

Generally, a CU has a prediction mode such as inter or intra. A CU includes one or more prediction units for purposes of signaling of prediction information (such as prediction mode details, displacement values, etc.) and/or prediction processing. A prediction unit (“PU”) has a luma prediction block (“PB”) and two chroma PBs. For an intra-predicted CU, the PU has the same size as the CU, unless the CU has the smallest size (e.g., 8×8). In that case, the CU can be split into four smaller PUs (e.g., each 4×4 if the smallest CU size is 8×8) or the PU can have the smallest CU size, as indicated by a syntax element for the CU. A CU also has one or more transform units for purposes of residual coding/decoding, where a transform unit (“TU”) has a luma transform block (“TB”) and two chroma TBs. A PU in an intra-predicted CU may contain a single TU (equal in size to the PU) or multiple TUs. The encoder decides how to partition video into CTUs, CUs, PUs, TUs, etc.

Or, for syntax according to the H.264/AVC standard, the encoder splits the content of a frame (or slice) into macroblocks. A macroblock (“MB”) includes luma sample values organized as luma blocks and corresponding chroma sample values organized as chroma blocks. The size of a MB is typically 16×16 luma sample values, organized as four 8×8 luma blocks. The chroma sample values are organized as two 8×8 chroma blocks (for YUV 4:2:0) format) or more chroma blocks (for YUV 4:2:2 or 4:4:4 format). For purposes of intra-picture prediction, inter-picture prediction and transforms, blocks can be further split into sub-blocks.

As used herein, the term “block” can indicate a macroblock, prediction unit, residual data unit, or a CB, PB or TB, or some other set of sample values, depending on context.

Returning to FIG. 3, the encoder represents an intra-coded block of a source frame (331) in terms of prediction from other, previously reconstructed sample values in the frame (331). For intra block copy (“BC”) prediction, an intra-picture estimator estimates displacement of a block with respect to the other, previously reconstructed sample values. An intra-frame prediction reference region is a region of samples in the frame that are used to generate BC-prediction values for the block. The intra-frame prediction reference region can be indicated with a block vector (“BV”) value. For intra spatial prediction for a block, the intra-picture estimator estimates extrapolation of the neighboring reconstructed sample values into the block. The intra-picture estimator can output prediction information (such as BV information for intra BC prediction or prediction mode (direction) for intra spatial prediction), which is entropy coded. An intra-picture prediction predictor applies spatial prediction information to determine intra prediction values or applies the BV information to determine intra BC prediction values.

The encoder (340) represents an inter-frame coded, predicted block of a source frame (331) in terms of prediction from reference frames. A motion estimator estimates the motion of the block with respect to one or more reference frames (369). When multiple reference frames are used, the multiple reference frames can be from different temporal directions or the same temporal direction. A motion-compensated prediction reference region is a region of sample values in the reference frame(s) that are used to generate motion-compensated prediction values for a block of sample values of a current frame. The motion estimator outputs motion information such as motion vector (“MV”) information, which is entropy coded. A motion compensator applies MVs to reference frames (369) to determine motion-compensated prediction values for inter-frame prediction.

The encoder can determine the differences (if any) between a block's prediction values (intra or inter) and corresponding original values. These prediction residual values are further encoded using a frequency transform, quantization and entropy encoding. For example, the encoder (340) sets values for quantization parameter (“QP”) for a picture, tile, slice and/or other portion of video using an approach described herein, and quantizes transform coefficients accordingly. The entropy coder of the encoder (340) compresses quantized transform coefficient values as well as certain side information (e.g., MV information, By information, QP values, mode decisions, parameter choices). Typical entropy coding techniques include Exponential-Golomb coding, Golomb-Rice coding, arithmetic coding, differential coding, Huffman coding, run length coding, variable-length-to-variable-length (“V2V”) coding, variable-length-to-fixed-length (“V2F”) coding, Lempel-Ziv (“LZ”) coding, dictionary coding, probability interval partitioning entropy coding (“PIPE”), and combinations of the above. The entropy coder can use different coding techniques for different kinds of information, can apply multiple techniques in combination (e.g., by applying Golomb-Rice coding followed by arithmetic coding), and can choose from among multiple code tables within a particular coding technique.

An adaptive deblocking filter is included within the motion compensation loop in the encoder (340) to smooth discontinuities across block boundary rows and/or columns in a decoded frame. Other filtering (such as de-ringing filtering, adaptive loop filtering (“ALF”), or sample-adaptive offset (“SAO”) filtering; not shown) can alternatively or additionally be applied as in-loop filtering operations.

The coded frames (341) and MMCO/RPS information (342) (or information equivalent to the MMCO/RPS information (342), since the dependencies and ordering structures for frames are already known at the encoder (340)) are processed by a decoding process emulator (350). The decoding process emulator (350) implements some of the functionality of a decoder, for example, decoding tasks to reconstruct reference frames. In a manner consistent with the MMCO/RPS information (342), the decoding process emulator (350) determines whether a given coded frame (341) needs to be reconstructed and stored for use as a reference frame in inter-frame prediction of subsequent frames to be encoded. If a coded frame (341) needs to be stored, the decoding process emulator (350) models the decoding process that would be conducted by a decoder that receives the coded frame (341) and produces a corresponding decoded frame (351). In doing so, when the encoder (340) has used decoded frame(s) (369) that have been stored in the decoded frame storage area (360), the decoding process emulator (350) also uses the decoded frame(s) (369) from the storage area (360) as part of the decoding process.

The decoded frame temporary memory storage area (360) includes multiple frame buffer storage areas (361, 362, . . . , 36n). In a manner consistent with the MMCO/RPS information (342), the decoding process emulator (350) manages the contents of the storage area (360) in order to identify any frame buffers (361, 362, etc.) with frames that are no longer needed by the encoder (340) for use as reference frames. After modeling the decoding process, the decoding process emulator (350) stores a newly decoded frame (351) in a frame buffer (361, 362, etc.) that has been identified in this manner.

The coded frames (341) and MMCO/RPS information (342) are buffered in a temporary coded data area (370). The coded data that is aggregated in the coded data area (370) contains, as part of the syntax of an elementary coded video bitstream, encoded data for one or more pictures. The coded data that is aggregated in the coded data area (370) can also include media metadata relating to the coded video data (e.g., as one or more parameters in one or more supplemental enhancement information (“SEI”) messages or video usability information (“VUI”) messages).

The aggregated data (371) from the temporary coded data area (370) are processed by a channel encoder (380). The channel encoder (380) can packetize and/or multiplex the aggregated data for transmission or storage as a media stream (e.g., according to a media program stream or transport stream format such as ITU-T H.222.0 I ISO/IEC 13818-1 or an Internet real-time transport protocol format such as IETF RFC 3550), in which case the channel encoder (380) can add syntax elements as part of the syntax of the media transmission stream. Or, the channel encoder (380) can organize the aggregated data for storage as a file (e.g., according to a media container format such as ISO/IEC 14496-12), in which case the channel encoder (380) can add syntax elements as part of the syntax of the media storage file. Or, more generally, the channel encoder (380) can implement one or more media system multiplexing protocols or transport protocols, in which case the channel encoder (380) can add syntax elements as part of the syntax of the protocol(s). The channel encoder (380) provides output to a channel (390), which represents storage, a communications connection, or another channel for the output. The channel encoder (380) or channel (390) may also include other elements (not shown), e.g., for forward-error correction (“FEC”) encoding and analog signal modulation.

### IV. Example Video Encoders

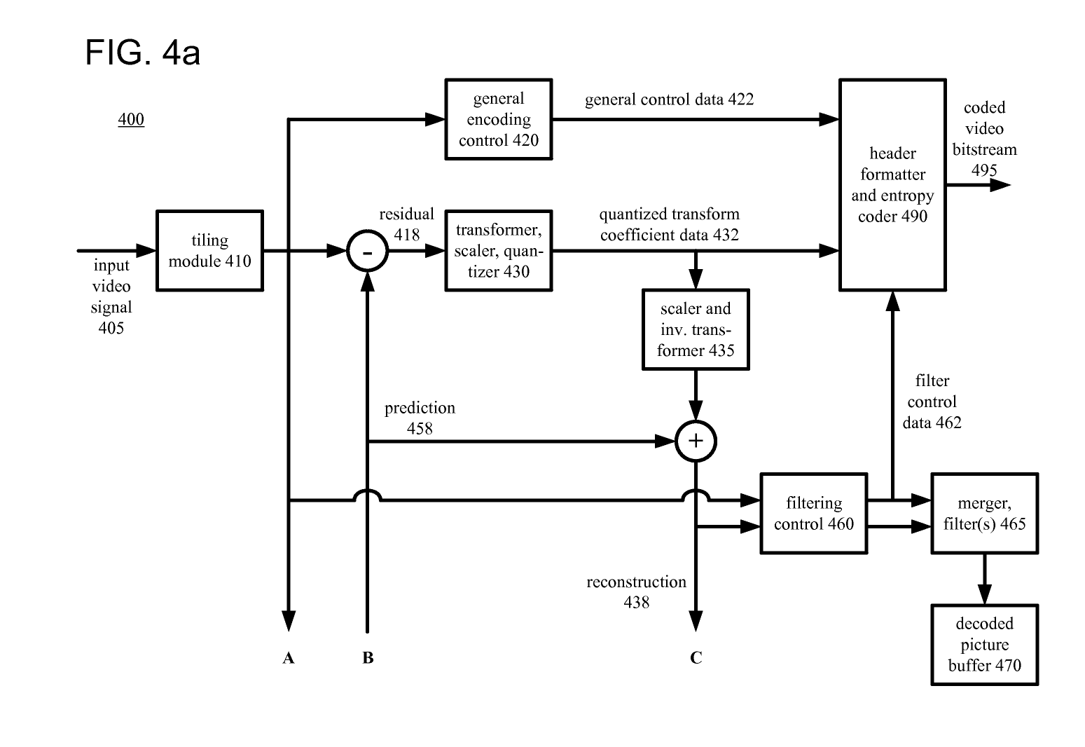

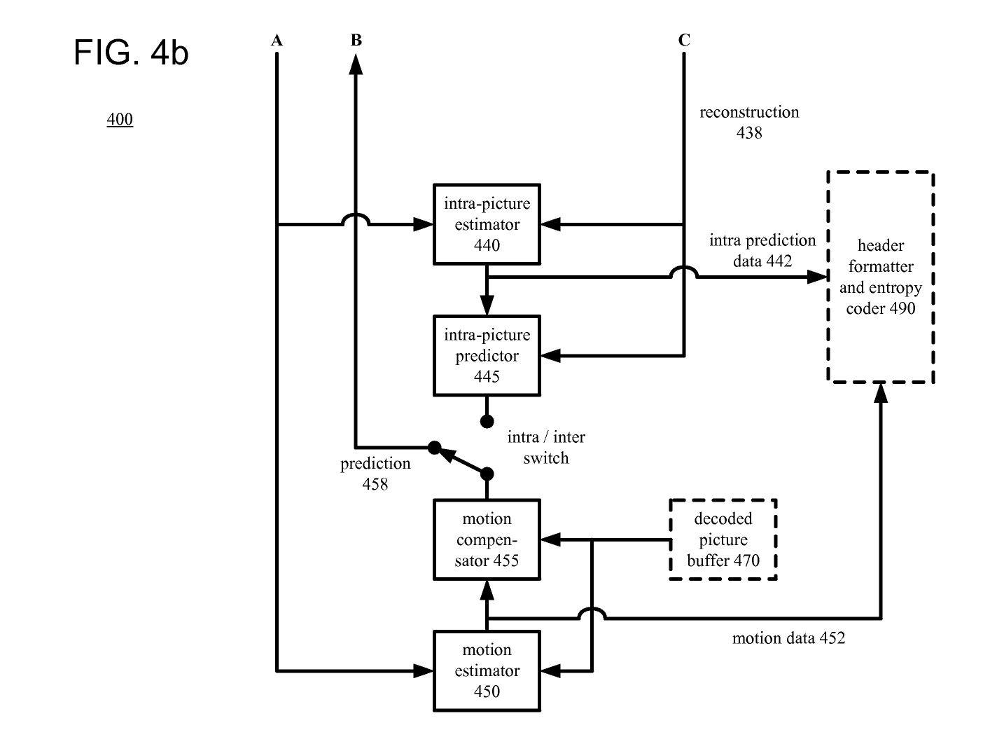

FIGS. 4a and 4b are a block diagram of a generalized video encoder (400) in conjunction with which some described embodiments may be implemented. The encoder (400) receives a sequence of video pictures including a current picture as an input video signal (405) and produces encoded data in a coded video bitstream (495) as output.

The encoder (400) is block-based and uses a block format that depends on implementation. Blocks may be further sub-divided at different stages, e.g., at the prediction, frequency transform and/or entropy encoding stages. For example, a picture can be divided into 64×64 blocks, 32×32 blocks or 16×16 blocks, which can in turn be divided into smaller blocks of sample values for coding and decoding. In implementations of encoding for the H.265/HEVC standard, the encoder partitions a picture into CTUs (CTBs), CUs (CBs), PUs (PBs) and TU (TBs). In implementations of encoding for the H.264/AVC standard, the encoder partitions a picture into MBs and blocks.

The encoder (400) compresses pictures using intra-picture coding and/or inter-picture coding. Many of the components of the encoder (400) are used for both intra-picture coding and inter-picture coding. The exact operations performed by those components can vary depending on the type of information being compressed.

A tiling module (410) optionally partitions a picture into multiple tiles of the same size or different sizes. For example, the tiling module (410) splits the picture along tile rows and tile columns that, with picture boundaries, define horizontal and vertical boundaries of tiles within the picture, where each tile is a rectangular region. In H.265/HEVC or H.264/AVC implementations, the encoder (400) partitions a picture into one or more slices, where each slice includes one or more slice segments.

The general encoding control (420) receives pictures for the input video signal (405) as well as feedback (not shown) from various modules of the encoder (400). Overall, the general encoding control (420) provides control signals (not shown) to other modules (such as the tiling module (410), transformer/scaler/quantizer (430), scaler/inverse transformer (435), intra-picture estimator (440), motion estimator (450) and intra/inter switch) to set and change coding parameters during encoding. In particular, the general encoding control (420) can manage decisions about encoding modes during encoding. The general encoding control (420) can also evaluate intermediate results during encoding, for example, performing rate-distortion analysis or setting QP values according to an approach described herein. The general encoding control (420) produces general control data (422) that indicates decisions made during encoding, so that a corresponding decoder can make consistent decisions. The general control data (422) is provided to the header formatter/entropy coder (490).

If the current picture is predicted using inter-picture prediction, a motion estimator (450) estimates the motion of blocks of sample values of a current picture of the input video signal (405) with respect to one or more reference pictures. The decoded picture buffer (470) buffers one or more reconstructed previously coded pictures for use as reference pictures. The motion estimator (450) can use results from block matching to make decisions about whether to perform certain stages of encoding (e.g., fractional-precision motion estimation, evaluation of coding modes and options for a motion-compensated block), as explained below.

When multiple reference pictures are used, the multiple reference pictures can be from different temporal directions or the same temporal direction.

The motion estimator (450) produces as side information motion data (452) such as MV data, merge mode index values, and reference picture selection data. The motion data (452) is provided to the header formatter/entropy coder (490) as well as the motion compensator (455).

The motion compensator (455) applies MVs to the reconstructed reference picture(s) from the decoded picture buffer (470). The motion compensator (455) produces motion-compensated predictions for the current picture.

In a separate path within the encoder (400), an intra-picture estimator (440) determines how to perform intra-picture prediction for blocks of sample values of a current picture of the input video signal (405). The current picture can be entirely or partially coded using intra-picture coding. Using values of a reconstruction (438) of the current picture, for intra spatial prediction, the intra-picture estimator (440) determines how to spatially predict sample values of a current block of the current picture from neighboring, previously reconstructed sample values of the current picture.

Or, for intra BC prediction using BV values, the intra-picture estimator (440) estimates displacement of the sample values of the current block to different candidate reference regions within the current picture. Or, for an intra-picture dictionary coding mode, pixels of a block are encoded using previous sample values stored in a dictionary or other location, where a pixel is a set of co-located sample values (e.g., an RGB triplet or YUV triplet).

The intra-picture estimator (440) produces as side information intra prediction data (442), such as information indicating whether intra prediction uses spatial prediction, intra BC prediction or a dictionary mode, prediction mode direction (for intra spatial prediction), BV values (for intra BC prediction) and offsets and lengths (for dictionary mode). The intra prediction data (442) is provided to the header formatter/entropy coder (490) as well as the intra-picture predictor (445).

According to the intra prediction data (442), the intra-picture predictor (445) spatially predicts sample values of a current block of the current picture from neighboring, previously reconstructed sample values of the current picture. Or, for intra BC prediction, the intra-picture predictor (445) predicts the sample values of the current block using previously reconstructed sample values of an intra-picture prediction reference region, which is indicated by a BV value for the current block. Or, for intra-picture dictionary mode, the intra-picture predictor (445) reconstructs pixels using offsets and lengths.

The intra/inter switch selects whether the prediction (458) for a given block will be a motion-compensated prediction or intra-picture prediction.

For a non-dictionary mode, the difference (if any) between a block of the prediction (458) and a corresponding part of the original current picture of the input video signal (405) provides values of the residual (418), for a non-skip-mode block. During reconstruction of the current picture, for a non-skip-mode block (that is not coded in dictionary mode), reconstructed residual values are combined with the prediction (458) to produce an approximate or exact reconstruction (438) of the original content from the video signal (405). (In lossy compression, some information is lost from the video signal (405).)

In the transformer/scaler/quantizer (430), for non-dictionary modes, a frequency transformer converts spatial-domain video information into frequency-domain (i.e., spectral, transform) data. For block-based video coding, the frequency transformer applies a discrete cosine transform (“DCT”), an integer approximation thereof, or another type of forward block transform (e.g., a discrete sine transform or an integer approximation thereof) to blocks of prediction residual data (or sample value data if the prediction (458) is null), producing blocks of frequency transform coefficients. The transformer/scaler/quantizer (430) can apply a transform with variable block sizes.

The scaler/quantizer scales and quantizes the transform coefficients. For example, the quantizer applies dead-zone scalar quantization to the frequency-domain data with a quantization step size that varies on a picture-by-picture basis, tile-by-tile basis, slice-by-slice basis, block-by-block basis, frequency-specific basis or other basis. The quantization step sizes can depend on a quantization value set using an approach described below. For example, one of the approaches described below indicates a quantization value for a frame, and quantization step sizes for the frame, slices of the frame, blocks within the frame, etc. are determined using the quantization value for the frame as a starting point. The quantized transform coefficient data (432) is provided to the header formatter/entropy coder (490).

In the scaler/inverse transformer (435), for non-dictionary modes, a scaler/inverse quantizer performs inverse scaling and inverse quantization on the quantized transform coefficients. When the transform stage has not been skipped, an inverse frequency transformer performs an inverse frequency transform, producing blocks of reconstructed prediction residual values or sample values. For a non-skip-mode block (that is not coded in dictionary mode), the encoder (400) combines reconstructed residual values with values of the prediction (458) (e.g., motion-compensated prediction values, intra-picture prediction values) to form the reconstruction (438). For a skip-mode block or dictionary-mode block, the encoder (400) uses the values of the prediction (458) as the reconstruction (438).

For intra-picture prediction, the values of the reconstruction (438) can be fed back to the intra-picture estimator (440) and intra-picture predictor (445). Also, the values of the reconstruction (438) can be used for motion-compensated prediction of subsequent pictures. The values of the reconstruction (438) can be further filtered. A filtering control (460) determines how to perform deblock filtering and SAO filtering on values of the reconstruction (438), for a given picture of the video signal (405). The filtering control (460) produces filter control data (462), which is provided to the header formatter/entropy coder (490) and merger/filter(s) (465).

In the merger/filter(s) (465), the encoder (400) merges content from different tiles into a reconstructed version of the picture. The encoder (400) selectively performs deblock filtering and SAO filtering according to the filter control data (462), so as to adaptively smooth discontinuities across boundaries in the pictures. Other filtering (such as de-ringing filtering or ALF; not shown) can alternatively or additionally be applied. Tile boundaries can be selectively filtered or not filtered at all, depending on settings of the encoder (400), and the encoder (400) may provide syntax within the coded bitstream to indicate whether or not such filtering was applied. The decoded picture buffer (470) buffers the reconstructed current picture for use in subsequent motion-compensated prediction.

The header formatter/entropy coder (490) formats and/or entropy codes the general control data (422) (including QP values), quantized transform coefficient data (432), intra prediction data (442), motion data (452) and filter control data (462). For the motion data (452), the header formatter/entropy coder (490) can select and entropy code merge mode index values, or a default MV predictor can be used. In some cases, the header formatter/entropy coder (490) also determines MV differentials for MV values (relative to MV predictors for the MV values), then entropy codes the MV differentials, e.g., using context-adaptive binary arithmetic coding. For the intra prediction data (442), the header formatter/entropy coder (490) can select and entropy code BV predictor index values (for intra BC prediction), or a default BV predictor can be used. In some cases, the header formatter/entropy coder (490) also determines BV differentials for BV values (relative to BV predictors for the BV values), then entropy codes the BV differentials, e.g., using context-adaptive binary arithmetic coding.

The header formatter/entropy coder (490) provides the encoded data in the coded video bitstream (495). The format of the coded video bitstream (495) can be a variation or extension of H.265/HEVC format, Windows Media Video format, VC-1 format, MPEG-x format (e.g., MPEG-1, MPEG-2, or MPEG-4), H.26x format (e.g., H.261, H.262, H.263, H.264), or another format.

Depending on implementation and the type of compression desired, modules of an encoder (400) can be added, omitted, split into multiple modules, combined with other modules, and/or replaced with like modules. In alternative embodiments, encoders with different modules and/or other configurations of modules perform one or more of the described techniques. Specific embodiments of encoders typically use a variation or supplemented version of the encoder (400). The relationships shown between modules within the encoder (400) indicate general flows of information in the encoder; other relationships are not shown for the sake of simplicity.

### V. Adaptive Quantizer Suitable for Game Video Rate Control

An adaptive quantizer can be positioned within the general encoding control 420, within the quantizer 430 or portions of both. Using a target bitrate, a base quantization level can be defined as a baseline to meet a quality goal. A time period can also be defined to have encoder output meet target bit rate constraints. That is, any short-term (instant) bitrate can be clipped by maximum bitrate allowed, and error tolerance of an average target bitrate can be controlled within a defined range (e.g., 3%-5%). Based on encoder feedback, an adaptive rate control updates quantization decisions from use of short-term (local) and long-term (global) statistics, and also based on a buffer level.

### A. Overview of an Embodiment of the Adaptive Quantizer

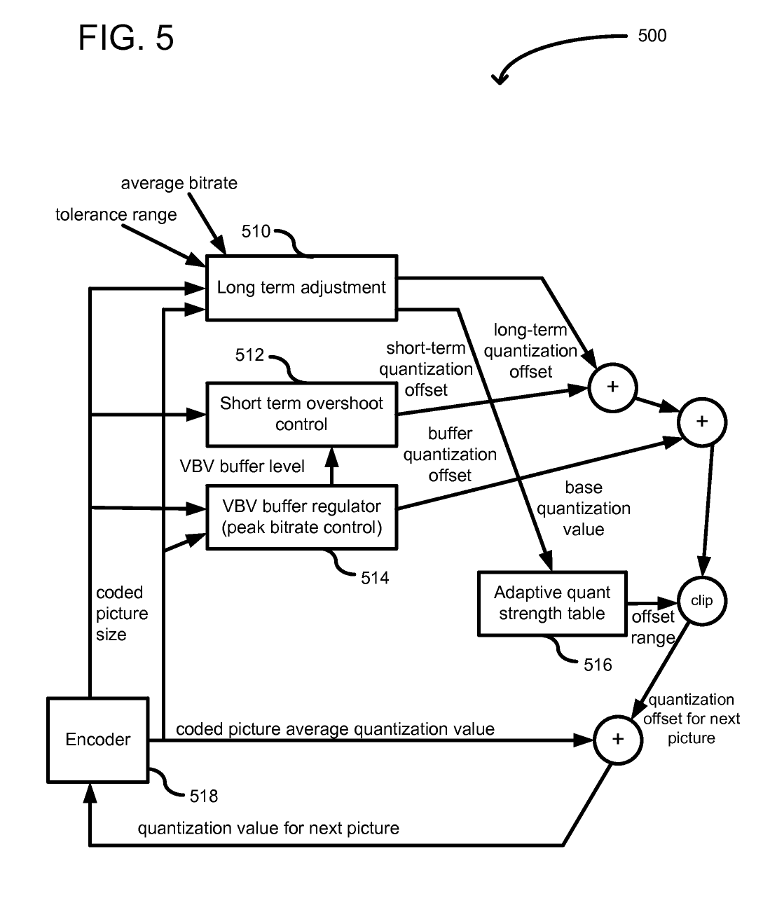

FIG. 5 shows an embodiment of the adaptive quantizer 500. The bitrate (and quality) can be regulated by three major components: a long-term quantization adjustment component 510, a short-term overshoot control component 512 (which can also be used to control undershoot in some embodiments), and a VBV (Video Buffer Verifier) buffer regulator component 514 for peak bitrate control. At the final stage, an adaptive quantization offset can be clipped using a table 516. Based on a current frame's average quantization value and other inputs, a quantization offset can be generated using the long-term quantization adjustment component 510, a short-term overshoot control component 512 and a VBV buffer regulator component 514. The offset can then be added to the current frame's quantization value to generate a quantization value for a next picture. The quantization value for the next picture can be used for encoding by the general encoding control 420 (in the encoder 518). For example, the quantization value for the next picture is used to set a default quantization step size for the next picture, which may be further modified for quantization step sizes for slices, blocks, etc. within the next picture. Generic processing nodes are indicated with a “+” sign and are used to mix several inputs in a desired fashion, as is well understood in the art.

The table 516 can be designed so that the offset is permitted to increase the quantization value for the next frame more quickly for lower base quantization values (depending, e.g., on the current frame and previous frames) and is constrained to increase the quantization value for the next frame more slowly for higher base quantization values. For example, the table can define slower maximum increasing speed for quantization levels between contiguous frames when the baseline quantization step is larger, in order to constrain the quality fluctuation across different frames by limiting further increases in quantization level. Additionally, the table can define faster maximum decreasing speed for quantization levels between contiguous frames when the baseline quantization step is larger, allowing faster return to lower quantization levels. Thus, the speed at which the quantization value changes can be dynamically controlled using the table and an input (baseline quantization value) based on the average quantization value. Additionally, the table can also define allowable offset values. The table can be dynamically modified or hardcoded.

The VBV buffer level regulator component 514 changes a current quantization value adaptively. For example, it changes quantization values to maintain reasonably low VBV buffer levels with increases or decreases in the quantization level.

Using the adaptive quantizer 500, a base quantization level can be maintained adaptively using encoder histogram information. For example, past levels can be used to determine a proper average complexity level globally, but within a certain time range.

### B. Long-Term Quantization Decision

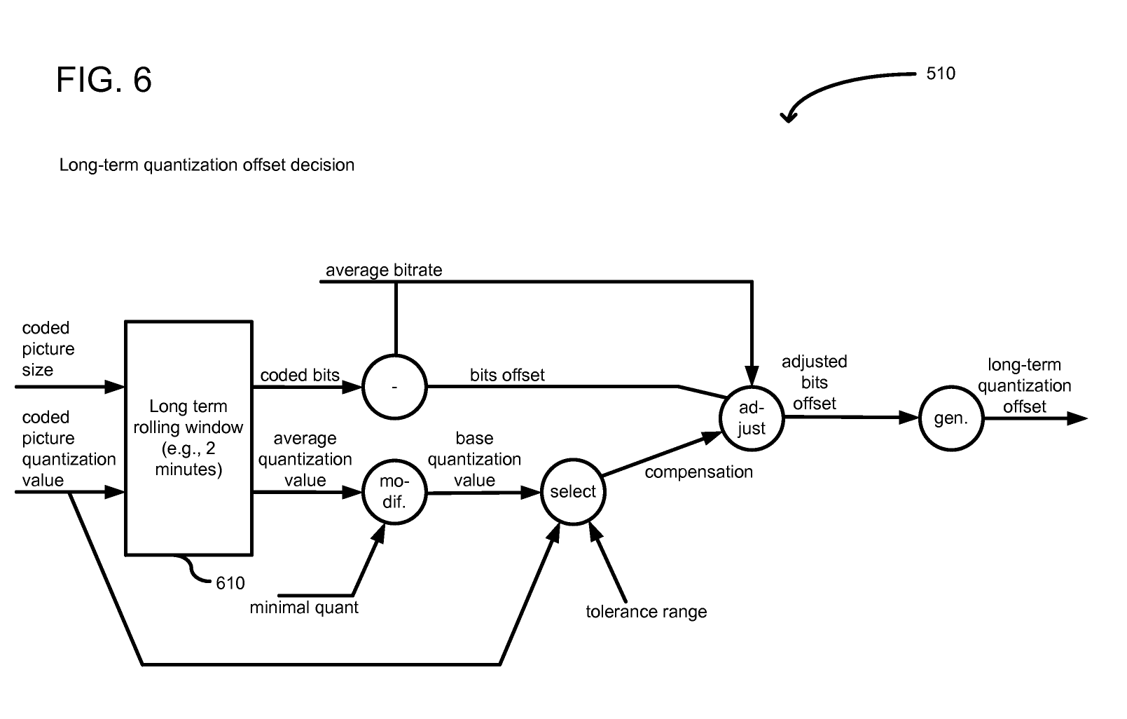

FIG. 6 shows an example embodiment of the long-term adjustment component 510, which can use long-term bit allocation to provide compensation for fluctuations in rate and quality due to high-complexity video. For example, the long-term adjustment component 510 can give a positive bias offset to video sections that have a quantization level above a given baseline. To adjust the bit rate in a long-term rolling window to meet a target bitrate, an accumulated coded bits offset can be generated and applied for N frame's bit allocation budget, wherein N can be any number, such as ¼ of a long-term sliding window length. Thus, some amount of bits from one or more simple frames in the sliding window can instead be allocated to one or more complex frames in the sliding window, so as to mitigate fluctuations in quality level.

The long-term adjustment component 510 can control counting of coding bits in a certain length of the rolling window (also called the sliding window). The sliding window can be relatively long in order to have a high probability that both static and high complexity sections of video are included from game play, for example. The length of the sliding window can vary depending on the particular implementation, but windows can be between 1 and 2 minutes, for example. The window can also be a certain number of frames of the video segment.

As can be seen, a long-term rolling window component 610 can receive as inputs, a coded picture size (for the current frame) and a coded picture quantization value (for the current frame). These values can be received from the encoder 518 (e.g., from the general encoding control (420) in the encoder of FIG. 4), as shown in FIG. 5 (there is no dependency from the decoder side), which generates these values substantially simultaneously. The long-term rolling window component 610 can generate, from these inputs, an encoded bits output that depends on coded picture sizes for pictures within the rolling window (e.g., an average or weighted average). A bits offset (budget based on average bitrate vs. actual encoded bits) can be generated through a difference between coded bits (within the sliding window) and the target average bitrate. The bits offset can indicate a surplus or deficit of bits. The long-term rolling window component 610 can be used to adjust bits budgeted for future frames within a predetermined period of time (which is typically not less than ¼ of sliding window or longer than one minute), e.g., borrowing bits from future frames to encode what is likely to be a complex next frame, or loaning bits to future frames after encoding many simple frames.

The long-term rolling window component 610 can also generate an average quantization value (within the sliding window), which is modified according to a minimal quantization (e.g., to verify that the average quantization value is at least as high as the minimal quantization value) to obtain the base quantization value. The base quantization value can be compared to the coded picture quantization value (for the current frame) and a tolerance range to select a compensation value. For example, the compensation value is selected based on a difference between the coded picture quantization value for the current frame and the base quantization value (within the rolling window), limited to be within the specified tolerance range. The compensation value can be used to adjust the bits offset to obtain an adjusted bits offset. The adjusted bits offset can be used with the average bitrate to generate the long-term quantization offset, mapping the adjusted bits offset to a long-term quantization offset.

As previously explained, the long-term quantization offset can be determined by reallocation of bits over a plurality of frames or for a predetermined period of time of the video stream.

### C. Short-Term Frame Coding Overshoot Control

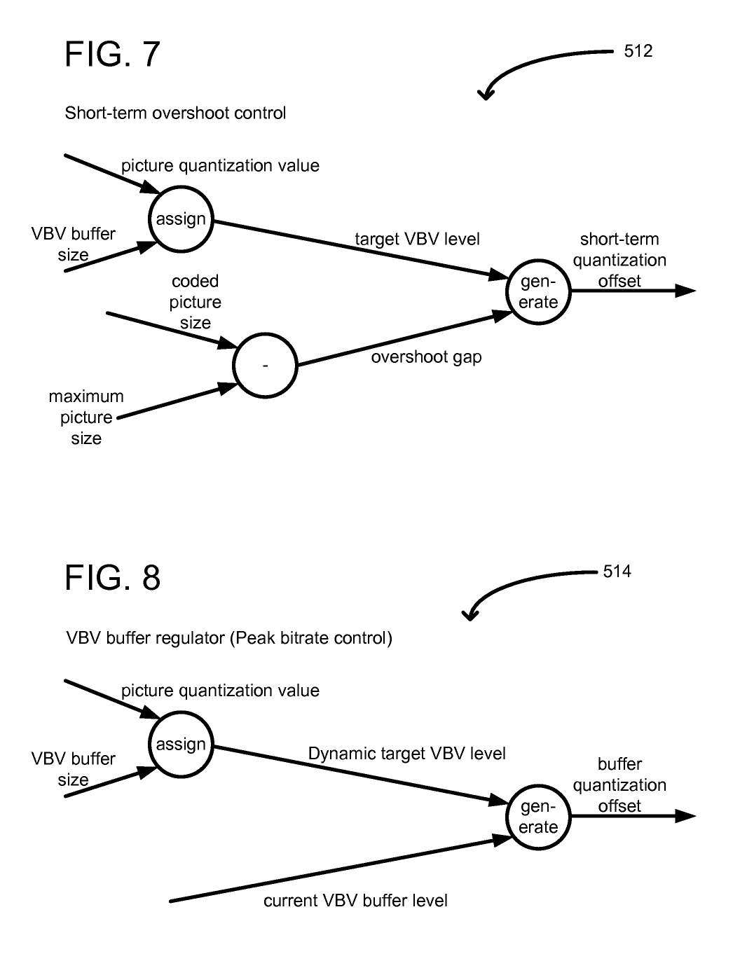

FIG. 7 shows further details of the short-term overshoot control component 512. The short term overshoot control component 512 takes action when individual frame coding bits overshoot a maximum picture size. The overshoot of frame coding bits could be caused by a rapid scene change or complexity spike, such as a frame coding size spike. If coding size exceeds a predetermined threshold, the short term overshoot control component 512 increases quantization level for the next frame based on the overshoot amount and the current VBV buffer level, which tends to quickly reduce the coded picture size for the next frame to compensate for the overshoot gap. The short-term overshoot control can also be applied to undershoot. In this case, the control component 512 can decrease quantization level for the next frame based on an undershoot amount and the current VBV buffer level, which tends to quickly increase the coded picture size for the next frame to compensate for the undershoot gap.

The short_term overshoot component can be described using the following formula:

Short_term_quant_offset=vbv_level scaler*overshoot_gap/bits_to_quant_ratio

As can be seen from FIG. 7, the short-term overshoot control receives the VBV buffer size and the picture average quantization value (for the current frame). These values are used to assign a target VBV level (e.g., as described in the next section). A difference can be taken between the current coded picture size and the maximum picture size to generate an overshoot gap. The overshoot gap and the target VBV level can be combined according to the formula shown above to generate the short-term quantization offset. That is, a target buffer level is scaled by the overshoot gap (a count of bits), and the resulting value is scaled by a factor (bits_to_quant_ratio) that relates an amount of bits to a change in quantization value.

### D. VBV Buffer Regulator and Peak Bitrate Control

FIG. 8 shows further details of the VBV buffer regulator 514. The peak bit rate is defined to have short-term bit rate constrained in a certain time range and is regulated by the VBV buffer model. By maintaining the VBV buffer level with a target VBV buffer level, an output bitrate is constrained by the peak bitrate. As shown in FIG. 8, the target VBV buffer level can be dynamically assigned based on current quantization level (for the current frame) and VBV buffer size, which allows for maintaining a relatively lower VBV buffer level. For example, a lower value of dynamic target VBV level can be assigned when the current quantization level is relatively high, and a higher value of dynamic target VBV level can be assigned when the current quantization level is relatively low. The dynamic VBV buffer level creates an additional “buffer” for coding complexity transition, or a delayed response from VBV buffer regulator, while helping to provide smooth complexity transitions and reduce quality variation. The VBV buffer regulator controls a buffer level to prevent an underflow condition, but can ignore any overflow condition. The average target bitrate is regulated by long-term quantization control.

As can be seen in FIG. 8, the VBV buffer regulator can use the VBV buffer size and the current quantization value (for the current frame) to assign a dynamic target VBV level. A difference can be taken between this dynamic target VBV level and a current buffer level, which is used to generate a buffer quantization offset (e.g., by mapping the difference to a value for the buffer quantization offset).

### E. Adaptive Quantization Offset Range

The adaptive quantization strength table 516 can further control the quantization offset. A base quantization value generated in the long-term adjustment component 510 can be used as a key for looking up values in the table 516. The table 516 can be pre-defined for an encoder or created dynamically. When coding consecutive frames, rate control can adjust quantization level to control the output bitrate. Adaptive quantization offset range is designed to make a frame transition smooth by limiting changes in quantization levels from frame to frame. The adaptive quantization offset range can have a positive high bound and negative low bound.

Given a low quantization level (for the base quantization value), a large high bound for the quantization offset allows a fast speed of increases in quantization level, but a very limited low bound for the quantization offset, so as to slow the speed of further decreases in quantization level. And vice versa, if current quantization level (for the base quantization value) is high, the high bound for the quantization offset is small and the low bound for the quantization offset is larger in magnitude (further negative), so it allows a slow speed of further increases in quantization level and a fast speed of decreases in quantization level.

An example offset range table is generated using the following formulas and is indexed using base quantization level:

highbound=1/sqrt(parameterH*quantization value)*factor_high_bound;

lowbound=−1*sqrt (parameterL*quantization value)*factor_low_bound.

Wherein the parameterH and parameterL are constants. Example tables are as follows:

static const Int AdaptiveQPDiffUpBound[AVC_NUM_QP] = {

| | |
|---|---|
| 6, 6, 6, 6, 6, 6, | /* 0~5 */ |
| 6, 6, 6, 6, 6, 6, | /* 6~11 */ |
| 6, 6, 5, 5, 5, 4, | /* 12~17 */ |
| 4, 4, 3, 3, 3, 3, | /* 18~23 */ |
| 3, 3, 2, 2, 2, 2, | /* 24~29 */ |
| 2, 2, 2, 1, 1, 1, | /* 30~35 */ |
| 1, 1, 1, 1, 1, 1, | /* 36~41 */ |
| 1, 1, 1, 1, 1, 1, | /* 42~47 */ |
| 1, 1, 1, 0 | /* 48~51 */ |

```
  };
  static const Int AdaptiveQPDiffLowBound[AVC_NUM_QP] = {
```

| | |
|---|---|
| 0, −1, −1, −1, −1, −1, | /* 0~5 */ |
| −1, −1, −1, −1, −1, −1, | /* 6~11 */ |
| −1, −1, −1, −1, −1, −1, | /* 12~17 */ |
| −1, −1, −1, −1, −2, −2, | /* 18~23 */ |
| −2, −2, −2, −2, −3, −3, | /* 24~29 */ |
| −3, −3, −3, −3, −3, −3, | /* 30~35 */ |
| −3, −3, −3, −3, −3, −3, | /* 36~41 */ |
| −3, −3, −3, −3, −3, −3, | /* 42~47 */ |
| −3,−3, −3, −3 | /* 48~51 */ |

};

Alternatively, the encoder uses tables defining different offset ranges.

### VI. Methods for the Adaptive Quantizer

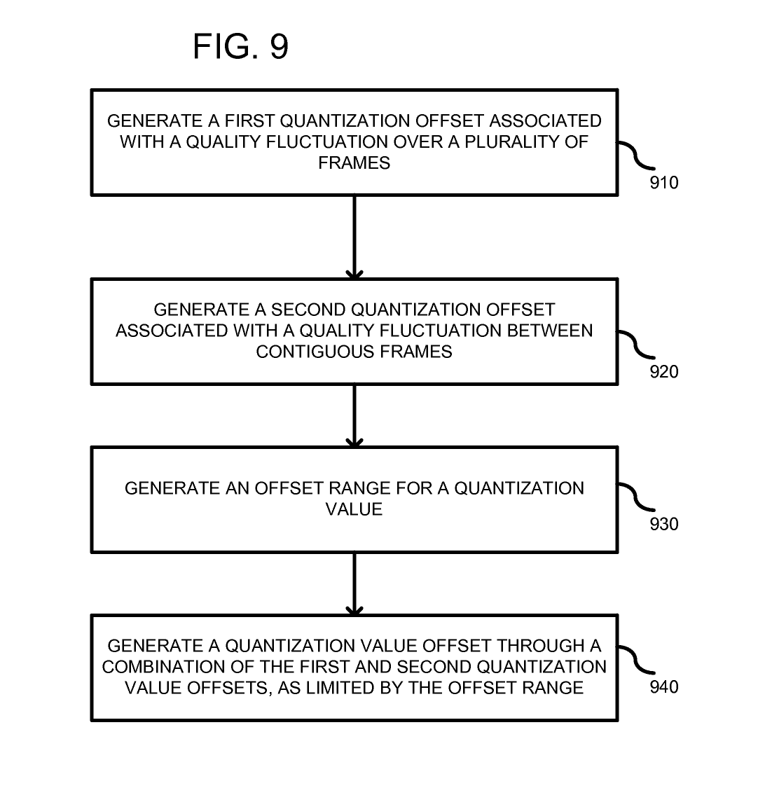

FIG. 9 is a flowchart of a method for adaptively maintaining a quality level of a video stream. In process block 910, a first quantization offset can be generated. For example, the first quantization offset can be a long-term quantization offset generated by the long-term adjustment component 510. This component can generate the first quantization offset to be associated with a quality fluctuation over a plurality of N frames of the video stream, where N can be any integer number. Alternatively, the component can generate the first quantization offset to be associated with a quality fluctuation over a period of time of the video stream. In any event, the offset can be generated using data (e.g., coded picture sizes, quantization levels) for time periods, such as 1 or more minutes or for a number of frames, typically greater than 30 frames. For this reason, it is typically thought of as “long term.” Additionally, adjustments can be made on a frame-by-frame basis and/or a MB-by-MB basis. Typically, the first quantization offset is generated by generating a baseline quantization level for a target bitrate of the video stream. The first baseline quantization level can be derived from an average quantization value (within the long-term window) and a minimum quantization value. In some embodiments, the first quantization offset can be skipped over a first N frames (e.g., 30 to 60 frames) so as to accumulate some statistical data from the beginning of the stream. Subsequently, the first quantization offset can be used in calculating a quantization value.

In any event, by using the first quantization offset, which accounts for results of encoding over many frames, the adaptive solution provides intelligent bias on bit allocation and quantization decisions locally within a frame and globally across different frames, based on a current quality level and within an allowed bitrate tolerance. Statistics from the encoding process are thereby used in generation of the quantization level. The long-term bits allocation can give a positive bias offset to video sections for quantization levels above a base line, so as to compensate for high complexity video sections. Additionally, the base quantization level is maintained adaptively based on encoder histogram information in the past (within the long-term window) to reflect a proper average complexity level globally.

In process block 920, a second quantization offset associated with a quality fluctuation between contiguous frames can be generated. For example, the short-term overshoot control component 512 can be used in generation of the second quantization offset. The short-term overshoot control component can use the coded picture size (for the current frame, compared to a maximum picture size) and the average quantization value (for the current frame) in determining the second quantization offset. Using the first and second quantization offsets, given a target bitrate, a base quantization level as a baseline is used to meet a quality goal. Additionally, a time period is defined to have the encoder output meet target bit rate constraints. That is, any short-term (instant) bitrate is clipped by maximum bitrate, and error tolerance of average target bitrate can be controlled within a defined range.

In process block 930, an offset range is generated for the quantization value. The offset range can control a rate of change of the quantization value relative to the current quantization value (for the current frame). The offset range can be generated by performing a table lookup using a base quantization level, where the table is dynamically generated or pre-defined for the encoder. In particular, a base quantization value generated by the long-term adjustment component can be derived from the current quantization level (within the long-term rolling window). The base quantization value can be used as a key to access the table and retrieve an offset range. Alternatively, the table can be hard coded so that generation is performed by using a hard coded value. The offset range can be used to limit a speed or a rate of change of the quantization value. For example, low quantization values can be increased more quickly than higher quantization values. Likewise, high quantization values can be decreased more quickly than lower quantization values. Thus, the table can allow for slow increasing speeds (in quantization levels) and fast decreasing speeds (in quantization levels) when the quantization value for the current frame is high.

In process block 940, a quantization value offset can be generated through a combination of the first and second quantization value offsets, as limited by the offset range. As can be seen in FIG. 5, the quantization value offset can be added to the current quantization value to determine a quantization value for the next frame of the video stream.

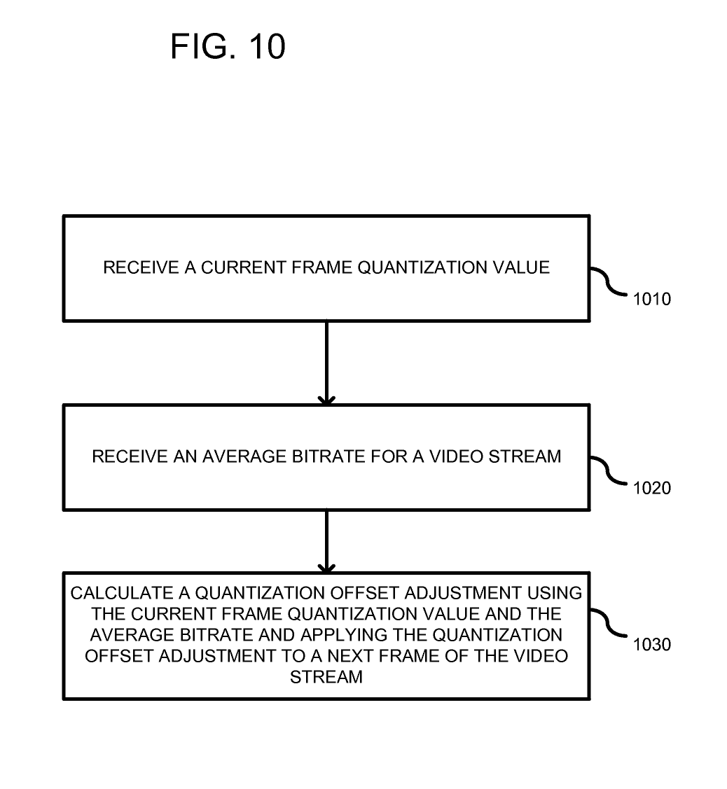

FIG. 10 shows another embodiment that can be used for adaptively maintaining a quality level. In process block 1010, a current frame quantization value can be received. For example, such a quantization value can be received from the encoder 518. In process block 1020, an average bitrate for the video stream can be received. In process block 1030, a quantization offset adjustment can be calculated using the current frame quantization value and the average bitrate. The calculated quantization offset adjustment can be applied to a next frame of the video stream, so as to maintain a substantially constant video quality within a tolerance level. The quantization offset adjustment can be calculated using results of encoding over a predetermined number of frames or a predetermined period of time. In some embodiments, the quantization offset adjustment can be further modified through a combination of a coded frame size, a maximum frame size, the current frame quantization value and a buffer size (see FIG. 7). The quantization offset adjustment can be further modified (limited) by calculating an offset range using a table to adjust a speed at which a next frame quantization value can change relative to the current frame quantization value. The video encoder can be positioned on a game console and the stream of pictures can be received from a user playing a video game.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. In a video encoder, a method of adaptively maintaining a quality level of a video stream, comprising:
generating a first quantization value offset associated with a quality fluctuation over a plurality of frames of the video stream or for a predetermined time period of the video stream;
generating a second quantization value offset associated with a quality fluctuation between contiguous frames of the video stream;
generating an offset range for a quantization value wherein the offset range controls a rate of change of the quantization value relative to a current quantization value; and
generating a quantization value offset to be used in a next frame of the video stream through a combination of the first and second quantization value offsets, as limited by the offset range, the quantization value offset being added to the current quantization value to determine a quantization value for the next frame of the video stream.

2. The method of claim 1, further including dynamically assigning a buffer level based on the current quantization value and generating a buffer quantization offset that is combined with the first and second quantization value offsets, as limited by the offset range, to generate the quantization value offset.

3. The method of claim 1, further including reading the current quantization value for a current frame and a coded frame size for use in generating the first quantization value offset.

4. The method of claim 1, further including determining a baseline quantization level for a target bitrate of a video stream and using the baseline quantization level in determining the first quantization value offset.

5. The method of claim 1, wherein generating the offset range includes performing a table lookup based on an average quantization value in a long-term rolling window.

6. The method of claim 1, wherein generating the offset range includes reading a table of values designed to increase the quantization value for the next frame more quickly for lower base quantization values and to increase the quantization value for the next frame more slowly for higher base quantization values.

7. The method of claim 1, wherein the number of frames with which the first quantization value offset is associated is greater than 30 frames or the predetermined period of time is longer than one minute.

8. The method of claim 1, wherein the first quantization value offset accounts for re-allocation of bits between a predetermined number of frames.

9. The method of claim 6, wherein the table includes values based on the following formulas:
highbound=1/sqrt(parameterH*quantization value)*factor_high_bound;
lowbound=−1*sqrt (parameterL*quantization value)*factor_low_bound.

10. The method of claim 1, wherein the encoder is positioned on a game console and the video stream is received from a user playing a video game or console screen.

11. A computer-readable storage storing instructions which, when executed, cause a computer to perform a method comprising:
receiving a current frame quantization value;
receiving an average bitrate for a video stream of frames being encoded; and
calculating a quantization offset adjustment using the current frame quantization value and the average bitrate and applying the quantization offset adjustment to a next frame of the video stream so as to maintain a substantially constant video quality within a tolerance level.

12. The computer-readable storage of claim 11, wherein the quantization offset adjustment is calculated using results of encoding over a predetermined number of frames or a predetermined period of time.

13. The computer-readable storage of claim 11, wherein the method further includes modifying the quantization offset adjustment through a combination of a coded frame size, a maximum coded frame size, the current frame quantization value and a buffer size.

14. The computer-readable storage of claim 11, wherein the method further includes modifying the quantization offset adjustment by calculating an offset range using a table to adjust a speed at which a next frame quantization value can change relative to the current frame quantization value.

15. The computer-readable storage of claim 11, wherein the method further includes adding the quantization offset adjustment to the current frame quantization value to calculate a next frame quantization value.

16. The computer-readable storage of claim 11, wherein the calculating the quantization offset adjustment includes taking a difference of current coded bits within a long-term rolling window and the average bitrate to generate a bits offset used to adjust a budget for bits of subsequent frames.

17. The computer-readable storage of claim 11, wherein the method further includes adding the quantization offset adjustment, which is a first quantization offset adjustment, to a second quantization offset adjustment associated with a quality fluctuation between contiguous frames of the video stream.

18. The computer-readable storage of claim 17, wherein the method further includes clipping the first and second quantization offset adjustments to an offset range, which controls a rate of change of a next frame quantization value relative to the current frame quantization value.

19. In a video encoder in a gaming platform, a method of adaptively maintaining a quality level of a video stream, comprising:
generating a first quantization value offset associated with a quality fluctuation over a plurality of frames of the video stream or for a predetermined time period of the video stream, wherein the first quantization value offset is generated, at least in part, by using a difference of an average bitrate and current coded bits within a long-term rolling window to determine a bit offset;
generating a second quantization value offset associated with a quality fluctuation between contiguous frames of the video stream, the second quantization value offset using a difference between a current coded frame size and a maximum frame size to calculate an overshoot gap and using the overshoot gap together with a current buffer size to generate the second quantization value offset;
generating an offset range for a quantization value wherein the offset range controls a rate of change of the quantization value relative to a current quantization value; and
generating a quantization value offset to be used in a next frame of the video stream through a combination of the first and second quantization value offsets, as limited by the offset range, the quantization value offset being added to the current quantization value to determine a quantization value for the next frame of the video stream.

20. The method of claim 19, wherein the offset range is generated using a table of values designed to increase the quantization value for the next frame more quickly for lower base quantization values and to increase the quantization value for the next frame more slowly for higher base quantization values.
